(19) United States
(12) Patent Application Publication
(10) Pub. No.: US 2026/0005229 A1
(43) Pub. Date: Jan. 1, 2026

(54) NEGATIVE ELECTRODE FOR ALL-SOLID-STATE BATTERY AND ALL-SOLID-STATE BATTERY INCLUDING SAME

(71) Applicant: Samsung SDI Co., Ltd., Yongin-si, Gyeonggi-do (KR)

(72) Inventors: Jinhoon YANG, Yongin-si (KR); Hyuksoo SHIN, Yongin-si (KR); Juhee SOHN, Yongin-si (KR); Jungho LEE, Yongin-si (KR); Sungwon JUNG, Yongin-si (KR)

(21) Appl. No.: 18/881,234

(22) PCT Filed: Dec. 6, 2023
(86) PCT No.: PCT/KR2023/020015

§ 371 Date: Jan. 3, 2025

(30) Foreign Application Priority Data
Dec. 21, 2022 (KR) 10-2022-0180853

(51) Int. Cl. H01M 4/36; H01M 4/02; H01M 4/38; H01M 4/587; H01M 10/052

(52) U.S. Cl. CPC H01M 4/366; H01M 4/38; H01M 4/587; H01M 10/052; H01M 2004/021; H01M 2004/027

(57) ABSTRACT

Disclosed are a negative electrode for an all solid-state battery and an all solid-state battery including the same, and the negative electrode for an all solid-state battery includes a current collector and a negative electrode coating layer on the current collector and including a mixture of metal particles and amorphous carbon, wherein an AID value defined by Equation 1 satisfies 5 nm or more and 600 nm or less.

### CROSS-REFERENCE TO RELATED APPLICATION

This application is a U.S. National Phase Patent Application of International Application Number PCT/KR2023/020015, filed on Dec. 6, 2023, which claims priority to and the benefit of Korean Patent Application No. 10-2022-0180853 filed in the Korean Intellectual Property Office on Dec. 21, 2022, the entire contents of which are incorporated herein by reference.

### TECHNICAL FIELD

Embodiments relate to a negative electrode for an all solid-state battery and an all solid-state battery including the same.

### BACKGROUND ART

Recently, with the rapid spread of electronic devices that use batteries, e.g., mobile phones, laptop computers, and electric vehicles, a demand for smaller, lighter and relatively high-capacity rechargeable lithium batteries is rapidly increasing. A rechargeable lithium battery has recently drawn attention as a driving power source for portable devices, as it has lighter weight and high energy density. Improving performances of rechargeable lithium batteries has been considered.

An all solid-state battery among the rechargeable lithium battery refers to a battery in which all materials are solids, and e.g., a battery using a solid electrolyte. For increasing energy density of the all solid-state battery, it is attempted to utilize a lithium metal as a negative electrode. However, this causes the volume expansion of lithium and the irreversible growth of dendrites during charging and discharging.

In order to solve these problems, the lithium metal, itself is not utilized and instead, the investigation for a negative electrode prepared by depositing lithium on a negative current collector during charging and discharging has been considered, which cause to show low power characteristics and to occur the severe short-circuit.

### Technical Problem

One embodiment provides a negative electrode for an all solid-state battery exhibiting excellent electrochemical characteristic.

Another embodiment provides an all solid-state battery including the negative electrode.

### Technical Solution

One embodiment provides a negative electrode for an all solid-state battery, including a current collector and a negative electrode coating layer on the current collector and including a mixture of metal particles and amorphous carbon, wherein an AID value defined by Equation 1 satisfies 5 nm or more and 600 nm or less.

$$AID = \sqrt{\frac{π}{3 \sqrt{3}} {10}^{- 3} ρ \frac{100 - L}{L} {Ad}^{3}} - d \qquad [ Equation 1 ]$$

(in Equation 1,
ρ is a density (g/cm³) of the mixture,
d is an average size (nm) of the metal particles,
L is an amount (wt %) of the metal particles, and,
A is a specific surface area (m²/g) of the amorphous carbon.)

The metal particle may be Ag, Au, Sn, Zn, Al, Mg, Ge, Cu, In, Ni, Bi, Pt, Pd, or a combination thereof.

The d which is the average size of the metal particles may be 3 to 30.

The L which is the amount of the metal particles may be 5 to 25.

The A which is the specific surface area of the amorphous carbon may be 30 to 100.

A ratio of a size of the amorphous carbon to a size of the metal particle may be 1:0.05 to 1:1.

The AID value defined by Equation 1 may be 10 to 400.

The amorphous carbon may be carbon black, acetylene black, denka black, Ketjen black, furnace black, activated carbon, or a combination thereof.

The density may be a value measured at 20° C. to 25° C.

Another embodiment provides an all solid-state battery including the negative electrode; a positive electrode, a solid electrolyte layer between the negative electrode and the positive electrode.

The negative electrode may further include a lithium-containing layer between the current collector and the negative electrode coating layer.

### Advantageous Effects

A negative electrode for an all solid-state battery may exhibit excellent electrochemical characteristics.

### BRIEF DESCRIPTION OF THE DRAWINGS

FIG. 1 is a schematic diagram showing the all solid-state battery according to one embodiment

FIG. 2 is a schematic diagram showing the all solid-state battery according to another embodiment.

FIG. 3 is a cross-sectional SEM image of the negative electrode prepared according to Example 1.

FIG. 4 is a cross-sectional SEM image of the negative electrode prepared according to Comparative Example 4.

FIG. 5 is a cross-sectional SEM image of the negative electrode prepared according to Example 2.

FIG. 6 is a cross-sectional SEM image of the negative electrode prepared according to Example 4.

FIG. 7 is a cross-sectional SEM image of the negative electrode prepared according to Comparative Example 1.

FIG. 8 is a cross-sectional SEM image of the negative electrode prepared according to Comparative Example 2.

### BEST MODE FOR PERFORMING INVENTION

Hereinafter, embodiments of the present invention are described in detail. However, these embodiments are merely examples, the present invention is not limited thereto, and the present invention is defined by the scope of the claims.

Terms used in the specification is used to explain embodiments, but are not intended to be limiting. Expressions in the singular include expressions in plural unless the context clearly dictates otherwise.

As used herein, the term “combination thereof may include a mixture, a laminate, a complex, a copolymer, an alloy, a blend, a reactant of constituents.

As used herein, the terms “comprise”, “include” or “have” are intended to designate that the performed characteristics, numbers, step, constituted elements, or a combination thereof is present, but it should be understood that the possibility of presence or addition of one or more other characteristics, numbers, steps, constituted element, or a combination are not to be precluded in advance.

The drawings show that the thickness is enlarged in order to clearly show the various layers and regions, and the same reference numerals are given to similar parts throughout the specification. If an element, such as a layer, a film, a region, a plate, and the like is referred to as being “on” or “over” another part, it may include cases where it is “directly on” another element, but also cases where there is another element in between. In contrast, when an element is referred to as being “directly on” another element, there are no intervening elements present.

In addition, herein, “layer” includes a shape totally formed on the entire surface or a shape partial surface, when viewed from a plane view.

Herein, “or” is not to be construed as an exclusive meaning, for example, “A or B” is construed to include A, B, A+B, and the like.

As used herein, when a definition is not otherwise provided, a particle diameter or size may be an average particle diameter. Such a particle diameter indicates an average particle diameter or size (D50) where a cumulative volume is 50 volume % in a particle size distribution. The particle size (D50) may be measured by a method well known to those skilled in the art, for example, by a particle size analyzer, or by a transmission electron microscopic image, or a scanning electron microscopic image. In some embodiments, a dynamic light-scattering measurement device is used to perform a data analysis, and the number of particles is counted for each particle size range, and from this, the average particle diameter (D50) value may be easily obtained through a calculation.

A negative electrode for an all solid-state battery according to one embodiment includes a current collector and a negative electrode coating layer including a mixture of metal particles and amorphous carbon, wherein the AID value defined by Equation 1 satisfies 5 nm or more and 600 nm or less. In one embodiment, the AID value defined by Equation 1 may be 5 nm to 400 nm, 5 nm to 300 nm, 5 nm to 250 nm, or 5 nm to 100 nm.

$$AID = \sqrt{\frac{π}{3 \sqrt{3}} {10}^{- 3} ρ \frac{100 - L}{L} {Ad}^{3}} - d \qquad [ Equation 1 ]$$

in Equation 1,
ρ is a density (g/cm³) of the mixture,
d is an average size (nm) of the metal particles,
L is an amount (wt %) of the metal particles, and,
A is a specific surface area (m²/g) of the amorphous carbon.

In one embodiment, the Equation 1 defines the distance between the metal particles, and if the distance between such metal particles is adjusted, lithium ions may be uniformly transferred during charging and discharging, thereby exhibiting suitable battery performances. This is because the probability of the lithium ions meeting the metal particles increases depending on the distance between the metal particles and this may provide the effect of maximizing the reaction between the metal particles and lithium ions.

In some embodiments, if the AID value defined by Equation 1 satisfies 5 nm or more, and 600 nm or less, excellent output and cycle-life characteristic may be exhibited. Such an effect for improving the output and cycle-life characteristic may be appropriately realized from the AID value defined b Equation 1 of 5 nm to 400 nm, 5 nm to 300 nm, 5 nm to 250 nm, or 5 nm to 100 nm.

In addition, in such a negative electrode coating layer, the distance between metal particles may be obtained by adjusting the average size and the density of metal particles, the amount of the metal particle, and the specific surface are of amorphous carbon, as indicated in Equation 1.

In Equation 1, the d is an average size of the metal particles and according to one embodiment, the average size of the metal particle may be 3 nm to 30 nm, or 3 nm to 25 nm. This represents that the d may be 3 to 30, or may be 3 to 25. In one embodiment, the average size of the metal particles may be measured from a TEM image.

In Equation 1, the L is an amount of the metal particles, for example, an amount of the metal particles included in the negative electrode coating layer. According to one embodiment, an amount of the metal particle may be 5 wt % to 25 wt %, or 5 wt % to 15 wt %. Therefore, the L may be 5 to 25, or 5 to 15. In one embodiment, the amount of the metal particles may be determined by the following procedures. A specimen for measuring, e.g., a negative electrode coating layer may be treated by increasing a temperature to a predetermined temperature at a predetermined increasing rate through a TGA (thermal gravimetric analysis) and measuring an amount of a metal which is a residue. The predetermined temperature may be, e.g., 800° C. to 1000°, and the predetermined increasing rate may be, e.g., 5° C./minute to 15° C./minute.

In Equation 1, the A may be the specific surface area of the amorphous carbon, and for example, may be a BET specific surface area. According to one embodiment, the specific surface area of the amorphous carbon may be 30 m²/g to 100 m²/g, 40 m²/g to 100 m²/g, 50 m²/g to 100 m²/g, or 50 m²/g to 90 m²/g. In one embodiment, the BET specific surface area may be determined by injecting gas onto the surface of the amorphous carbon, injecting it into a U-shaped sample cell, and measuring the amount of the adsorbed gas utilizing adsorption of gas via a thermal conductivity detector. The gas may be nitrogen gas or a mixed gas of nitrogen gas and helium gas. In the mixed gas, a mixing ratio of the nitrogen gas and the helium gas may be appropriately adjusted.

In Equation 1, the p is the density of the mixture. For example, it is the density of the mixture of the metal particles and the amorphous carbon. To explain this in more detail, it may be the density of the metal particles supported on the amorphous carbon, and may indicate the density if the metal particles are supported on the amorphous carbon. The density may be a true density and may be a value measured at 20° C. to 25° C. (the density may be varied depending on the type of the metal. The density of the mixture, e.g., metal particles, e.g., Ag, supported on the amorphous carbon, may be 10.00 g/cm³ to 10.5 g/cm³.

In one embodiment, the mixture may be one by physically mixing the metal particles with the amorphous carbon, or one by supporting the metal particles on the amorphous carbon.

In one embodiment, the metal particles may be Ag, Au, Sn, Zn, Al, Mg, Ge, Cu, In, Ni, Bi, Pt, Pd, or a combination thereof, and according to one embodiment, it may be Ag. The metal forms a solid solution with lithium ions, and thus, the inclusion of such a metal in the negative electrode coating layer may render to further enhance the electrical conductivity of the negative electrode and to improve overvoltage characteristic, and to improve efficiency.

As such, if ρ, d, L, and A which are the factors for defining the AID value of Equation 1 satisfies the above condition, an AID value of 5 nm or more and 600 nm or less may be obtained, which may provide the suitable output characteristic and cycle-life characteristic.

In one embodiment, the negative electrode coating layer refers to a layer that helps the movement of lithium ions released from the positive active material during charging and discharging of the all solid-state battery to the negative electrode, thereby facilitating their deposition on the surface of the current collector. For example, a lithium deposition layer may be formed due to the deposition of lithium ions between the current collector and the negative electrode coating layer, and the lithium deposition layer acts as a negative electrode active material, and this negative electrode is generally referred as a deposition-type negative electrode. The metal and amorphous carbon included in the negative electrode coating layer does not act as a negative active material which directly participates in the charge and discharge reaction. In one embodiment, the lithium titanium oxide particle does not also act as a negative active material which directly participates in the charge and discharge reaction. Such a deposition-type negative electrode represents a negative electrode that does not include a negative active material during the battery preparation, but the lithium deposition layer acts as a negative active material.

The amorphous carbon may be carbon black, acetylene black, denka black, Ketjen black, furnace black, activated carbon, or a combination thereof.

The carbon black may be Super P (available from Timcal, Ltd.). The amorphous carbon may be carbon black, acetylene black, denka black, Ketjen black, or a combination thereof.

In one embodiment, the improvements in the output and cycle-life characteristics owing to the negative electrode which satisfies in Equation 1, may be more effectively obtained, if the size of the metal particles is the same, or smaller than amorphous carbon. For example, the size ratio of the amorphous carbon and the metal particle may be 1:0.05 to 1:1, or 1:0.05 to 1:0.5.

The average size of the amorphous carbon may be not limited, as long as it satisfies the size ratio to the metal particle, but, e.g., May 3 nm to 600 nm, 3 nm to 500 nm, 6 nm to 500 nm, or 6 nm to 100 nm.

In the negative electrode coating layer according to one embodiment, an amount of the amorphous carbon may be, based on the total 100 wt % of the negative electrode coating layer, 50 wt % to 98 wt %, 70 wt % to 95 wt %, or 70 wt % to 90 wt %.

If the amount of the metal or the carbonaceous material is included in the range, the metal may be uniformly distributed in the carbonaceous material. In addition, if the amounts of the metal and the carbonaceous material are within the range, the lithium deposition layer formed by moving lithium ions released from the positive active material to the negative electrode, may be substantially and mostly formed between the current collector and the negative electrolyte layer, thereby effectively preventing shortcomings such as short circuit, side reaction with the electrolyte, and the crack formation on the negative electrode due to the occurrence of lithium deposition on the surface of the negative electrode layer.

The amorphous carbon may single particles, a secondary particle in which a plurality of primary particles is agglomerated, or combinations thereof. If the amorphous carbon is single particles, it may have an average particle diameter of 100 nm or less, e.g., a nanosized of 10 nm to 100 nm.

Furthermore, if the carbon-based material is an agglomerated product, the particle diameter of the primary particle may be 20 nm to 100 nm and the particle diameter of the secondary particle may be 1 μm to 20 μm.

In one embodiment, the particle diameter of the primary particle may be 20 nm or more, 30 nm or more, 40 nm or more, 50 nm or more, 60 nm or more, 70 nm or more, 80 nm or more, or 90 nm or more, and 100 nm or less, 90 nm or less, 80 nm or less, 70 nm or less, 60 nm or less, 50 nm or less, 40 nm or less, or 30 nm or less.

In one embodiment, the particle diameter of the secondary particle may be 1 μm or more, 3 μm or more, 5 μm or more, 7 μm or more, 10 μm or more, or 15 μm or more, and 20 μm or less, 15 μm or less, 10 μm or less, 7 μm or less, 5 μm or less, or 3 μm or less.

The shape of the primary particle may be spherical, oval, plate-shaped, or a combination thereof, and in one embodiment, the shape of the primary particle may be spherical, oval, or combinations thereof.

The negative electrode coating layer may further include a binder.

The binder may be a non-water-soluble binder, a water-soluble binder, or a combination thereof.

The non-water-soluble binder, for example, may be polyvinyl chloride, carboxylated polyvinyl chloride, polyvinyl fluoride, an ethylene oxide-containing polymer, an ethylene propylene copolymer, polystyrene, polyvinyl pyrrolidone, polyurethane, polytetrafluoroethylene, polyvinylidene fluoride, polyethylene, polypropylene, polyamideimide, polyimide, polyacrylate, or a combination thereof.

The water-soluble binder may be a rubber binder or a polymer resin binder. The rubber binder may be selected from a styrene-butadiene rubber, an acrylated styrene-butadiene rubber, an acrylonitrile-butadiene rubber, an acryl rubber, a butyl rubber, a fluorine rubber, or a combination thereof. The polymer resin binder may be selected from polyethylene oxide, polyvinyl pyrrolidone, polyepichlorohydrine, polyphosphazene, polyacrylonitrile, an ethylene propylenediene copolymer, polyvinyl pyridine, chlorosulfonated polyethylene, latex, a polyester resin, an acrylic resin, a phenol resin, epoxy resin, polyvinyl alcohol, or a combination thereof.

If the water-soluble binder is used as a negative electrode binder, a thickener for imparting viscosity may be used together with, and the thickener, for example, may include a cellulose compound. The cellulose compound may be one or more of carboxymethyl cellulose, hydroxypropylmethyl cellulose, methyl cellulose, alkali metal salts thereof, or a combination thereof. The alkali metal may be Na, K, or Li. The thickener may be included in an amount of 0.1 parts by weight to 3 parts by weight based on 100 parts by weight of the negative active material. The cellulose compound may serve as a binder.

The binder is not limited thereto, and any binder may be available as a binder used in the related art, and an amount thereof may also be appropriately adjusted.

The binder may be included, based on the total 100 wt % of the negative electrode coating layer, at 1 to 15 wt %, and for example, the binder may be included, based on the total 100 wt % of the negative electrode layer, at 1 wt % or more, 2 wt % or more, 3 wt % or more, 4 wt % or more, 5 wt % or more, 6 wt % or more, 7 wt % or more, 8 wt % or more, 9 wt % or more, 10 wt % or more, 11 wt % or more, 12 wt % or more, 13 wt % or more, or 14 wt % or more, and 15 wt % or less, 14 wt % or less, 13 wt % or less, 12 wt % or less, 11 wt % or less, 10 wt % or less, 9 wt % or less, 8 wt % or less, 7 wt % or less, 6 wt % or less, 5 wt % or less, 4 wt % or less, 3 wt % or less, or 2 wt % or less.

In the case of including the binder at the amount of the above range in the negative active material layer, the electrical resistance and the adherence may be improved to increase characteristics of the all solid battery (battery capacity and power characteristic.

The negative active material layer may further include additives, e.g., a conductive material, a filler, a dispersing agent, an ion conductive material, or the like. The filler, the dispersing agent, the ion conductive material, or the like. which may be included in the negative active material layer, may be materials known in the related art which are generally used in the all solid battery.

The negative electrode according to one embodiment may further include a lithium-containing layer between the current collector and the negative electrode coating layer.

The lithium-containing layer is a metal layer including lithium, which may serve, e.g., as a lithium reservoir.

The lithium-containing layer may be a lithium deposition layer formed by depositing the lithium ions after moving lithium ions released from the positive active materials to the negative electrode during charging, and in this case, the lithium-containing layer may refer as a lithium deposition layer.

The lithium-containing may be a layer including lithium or a lithium alloy.

The lithium alloy includes lithium and ma include a metal being capable of alloying with lithium. The metal being capable of alloying with lithium may be Ag, Au, Mg, In, Si, Sn, Al, Ge, Pb, Bi, Sb Si—Y alloy (where Y is an alkali metal, an alkaline-earth metal, group 13 element, group 14 elements, a transition metal, a rare earth element, or a combination thereof, but is not Si), Sn—Y alloy (where Y is an alkali metal, an alkaline-earth metal, group 13 element, group 14 elements, a transition metal, a rare earth element, or a combination thereof, but is not Sn), or the like. The element Y may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

The thickness of the lithium-containing layer may be 1 μm to 1000 μm, 1 μm to 500 μm, 1 μm to 200 μm, 1 μm to 150 μm, 1 μm to 100 μm, or 1 μm to 50 μm. If the thickness of the lithium-containing layer satisfies in the range, it may effectively perform the role of a lithium reservoir and the cycle-life characteristics may be further enhanced.

If the lithium-containing layer is the lithium deposition layer, the lithium deposition layer may be formed by releasing lithium ions from a positive active material during charging, passing through the solid electrolyte and moving move to the negative electrode, and consequently, the lithium is participated and deposited on the negative current collector, after fabricating the battery.

The charging may be a formation process which may be performed at 0.05 C to 1 C at 25° C. to 50° C. once to three time. During discharging, lithium included in the lithium-containing layer is ionized to move to the positive direction, and thus, this lithium may be used as a negative active material.

In one embodiment, as the lithium-containing layer is positioned between the current collector and the negative active material layer, the negative electrode coating layer may serve as a protecting layer for the lithium-containing layer, and thus, the deposition growth of lithium dendrite may be suppressed. This enables the inhibition of short-circuit and capacity fading of the all solid-state battery and resultantly improves the cycle-life of the all solid-state battery.

The current collector may be, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may have a foil shape or a sheet shape. A thickness of the negative electrode current collector may be 1 μm to 20 μm, 5 μm to 15 μm, or 7 μm to 10 μm.

The current collector may include the metal as a substrate and may further include a thin film on the substrate. The thin membrane may include an element being capable of forming an alloy with lithium, for example, gold, silver, zinc, tin, indium, silicon, aluminum, bismuth, or a combination thereof, but is not limited thereto and any elements as long as forming an alloy with lithium in the related arts. If the current collector further includes a thin membrane, if the lithium is deposited during charging to form the lithium-containing layer, thereby further improving the cycle-life characteristics of the all solid-state battery.

A thickness of the thin membrane may be 1 nm to 800 nm, 10 nm to 700 nm, 50 nm to 600 nm, or 100 nm to 500 nm. If the thickness of the thin membrane is within the range, the cycle-life characteristics may be further enhanced.

Another embodiment provides an all solid-state battery including the negative electrode, a positive electrode, and a solid electrolyte layer between the negative electrode and the positive electrode.

The solid electrolyte included in the solid electrolyte layer may be an inorganic solid electrolyte such as a sulfide-included solid electrolyte, an oxide-included solid electrolyte, a halide-included solid electrolyte, and the like, or a solid polymer electrolyte. In one embodiment, the solid electrolyte may be a sulfide-included solid electrolyte, for example, an argyrodite-type sulfide-included solid electrolyte. Such sulfide-included solid electrolyte may have excellent ionic conductivity and excellent cycle-life characteristics within the wider operation range, than other solid electrolytes such as an oxide-included solid electrolyte.

The sulfide-included solid electrolyte may be Li₂S—P₂S₅, Li₂S—P₂S₅—LiX (where X is an halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each an integer of 0 or more and 12 or less, Z is one of Ge, Zn, or Ga), Li₂S—GeS₂, Li₂S—SiS₂—Li₃PO₄, Li₂S—SiS₂-LiₚMO_{q} (where p and q are each an integer of 0 or more and 12 or less and M is one of P, Si, Ge, B, Al, Ga, or In), LiₐM_{b}P_{c}SₐAₑ (where a, b, c, d, and e are each an integer of 0 or more and 12 or less, M is Ge, Sn, Si, or a combination thereof, and A is one of F, Cl, Br, or I). For example, it may be Li₂₋ₓPS₆₋ₓFₓ (0≤x≤2), Li₂₋ₓPS₆₋ₓClₓ (0≤x≤2), Li₂₋ₓPS₆₋ₓBrₓ (0≤x≤2) or Li₂₋ₓPS₆₋ₓIₓ (0≤x≤2). Furthermore, specifically, it may be Li₃PS₄, Li₃PS₄, Li₂P₃S₁₁, Li₂PS₆, Li₆PS₅Cl, Li₆PS₅Cl, Li₆PS₅Br, Li₆PS₅I, Li_{5.8}PS_{4.8}Cl_{1.2}, Li_{6.2}PS_{5.2}Br_{0.8}, or the like.

The sulfide-included solid electrolyte may be prepared, for example, by mixing Li₂S and P₂S₅ at a mole ratio of 50:50 to 90:10, or 50:50 to 80:20. In the range of the mixing ratio, the sulfide-included solid electrolyte exhibiting excellent ionic conductivity may be prepared. As other components, SiS₂, GeS₂, B₂S₃, or the like may be further included thereto, thereby further improving ionic conductivity. The mixing procedure may be performed by a mechanical milling or a solution method. The mechanical milling may be performed by adding starting raw material, a ball mill, or the like in a reactor and vigorously stirring to pulverize the starting raw material and to mix them together. The solution method may provide a solid electrolyte as a precipitate by mixing starting raw material in a solvent. Furthermore, after mixing, a heat-treatment may be further performed. If the heat treatment is further performed, the crystal of the solid electrolyte may be further solidified.

The sulfide-included solid electrolyte may be amorphous or crystalline, or a mixture thereof. The sulfide-based solid electrolyte may be a commercial solid electrolyte.

The oxide-included inorganic solid electrolyte may be, e.g., Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTIO₃, Pb(Zr,Ti)O₃ (PZT), Pb₁₋ₓLaₓZr_{1-y}Ti_{y}O₃ (PLZT) (0≤x<1, 0≤y<1), Pb(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y} (Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ included ceramics, Garnet ceramics Li₃₊ₓLa₃M₂O₁₂ (where M=Te, Nb, or Zr, x is an integer of 1 to 10), or a mixture thereof.

The halide-included solid electrolyte may include a Li element, a M element (where M is a metal except for Li), and a X element (where X is a halogen. The X may be, for example, F, Cl, Br and I. Specifically, the halide-based solid electrolyte may include at least one of Br and Cl, as the X. In addition, the M may be, for example, a metal element such as Sc, Y, B, Al, Ga, In, and the like.

The composition of the halide-included solid electrolyte is not limited, but the halide-included solid electrolyte may be represented by Li₆₋₃ₐMₐBr_{b}Cl_{c} (where, M is a metal, except for Li, 0<a<2, 0≤b≤6, 0≤c≤6, b+c=6). The a may be 0.75 or more, or 1 or more, and the a may be 1.5 or less. The b may be 1 or more, or 2 or more. Furthermore, the c may be 3 or more, or 4 or more. The exemplary of the halide-based solid electrolyte may be Li₃YBr₆, Li₃YCl₆ or Li₃YBr₂Cl₄.

The solid polymer electrolyte may be at least one selected from, e.g., polyethylene oxide, poly(diallyldimethylammonium)trifluoromethanesulfonylimide (poly(diallyldimethylammonium)TFSI), Cu₃N, Li₃N, LiPON, Li₃PO₄·Li₂S·SiS₂, Li₂S·GeS₂·Ga₂S₃, Li₂O·11Al₂O₃, Na₂O·11Al₂O₃, (Na, Li)₁₊ₓTi₂₋ₓAlₓPO₄₃ (0.1≤x≤0.9), Li₁₊ₓHf₂₋ₓAlₓ (PO₄)₃ (0.1≤x≤0.9), Na₃Zr₂Si₂PO₁₂, Li₃Zr₂Si₂PO₁₂, Na₅ZrP₃O₁₂, Na₅TiP₃O₁₂, Na₃Fe₂P₃O₁₂, Na₄NbP₃O₁₂, Na-Silicates, Li_{0.3}La_{0.5}TiO₃, Na₅MSi₄O₁₂ (where M is a rare earth elements such as Nd, Gd, Dy, or the like) Li₅ZrP₃O₁₂, Li₅TiP₃O₁₂, Li₃Fe₂P₃O₁₂, Li₄NbP₃O₁₂, Li₁₊ₓ(M,Al,Ga)ₓ(Ge_{1-y}Ti_{y})₂₋ₓ(PO₄)₃ (x≤0.8, 0≤y≤1.0, M is Nd, Sm, Eu, Gd, Tb, Dy, Ho, Er, Tm, or Yb), Li_{1+x+y}QₓTi₂₋ₓSi_{y}P_{3-y}O₁₂ (0<x≤0.4, 0<y≤0.6, Q is Al or Ga), Li₆BaLa₂Ta₂O₁₂, Li₂La₃Zr₂O₁₂, Li₅La₃Nb₂O₁₂, Li₅La₃M₂O₁₂ (M is Nb, Ta), or Li₇₊ₓAₓLa₃₋ₓZr₂O₁₂ (0<x<3, A is Zn).

The solid electrolyte may have a particle shape, and may have an average particle diameter D50 of 5.0 μm or less, for example, 0.1 μm to 5.0 μm, 0.5 μm to 5.0 μm, 0.5 μm to 4.0 μm, 0.5 μm to 3.0 μm, 0.5 μm to 2.0 μm, or 0.5 μm to 1.0 μm.

The solid electrolyte layer may further include a binder. The binder may be a styrene butadiene rubber, polytetrafluoroethylene, polyvinylidene fluoride, polyethylene, an acrylate-based polymer, or a combination thereof, but is not limited thereto, and may be any material which is generally used in the related art. The acrylate-based polymer may be butyl acrylate, polyacrylate, polymethacrylate, or a combination thereof.

The solid electrolyte layer may be prepared by adding a solid electrolyte to a binder solution, coating it on a substrate film, and drying it. The binder solution may include isobutylyl isobutylate, xylene, toluene, benzene, hexane, or a combination thereof, as a solvent. The solid electrolyte layer preparation is widely known in the art, so a detailed description thereof will be omitted in the specification.

The positive electrode includes a current collector and a positive active material layer on the current collector. The positive active material layer may include a positive active material. The positive active material may include a lithiated compound that reversibly intercalate and deintercalate lithium ions, or a sulfur-included compound.

The lithiated compound may include one or more composite oxides of a metal selected from cobalt, manganese, nickel, and a combination thereof, and lithium. The examples of the lithiated compound may be, LiₐA_{1-b}B¹_{b}D¹₂ (0.90≤a≤1.8, 0≤b≤0.5); LiₐE_{1-b}B¹_{b}O_{2-c}D₁_{_{c}} (0.90≤a≤1.8, 0≤b≤0.5, 0≤c≤0.5); LiₐE_{2-b}B¹_{b}O_{4-c}D¹_{c} (0.90≤a≤1.8, 0≤b≤0.5, 0≤c≤05); LiₐNi_{1-b-c}Co_{b}B¹_{c}D¹_{α} (0.90≤a≤1.8, 0≤b≤0.5, 0≤c≤0.5, 0≤α≤2); LiₐNi_{1-b-c}Co_{b}B¹_{c}O_{2-α}F¹_{α} (0.90≤a≤1.8, 0≤b≤0.5, 0≤c≤0.5, 0<α<2); LiₐNi_{1-b-c}Co_{b}B¹_{c}O_{2-α}F¹₂ (0.90≤a≤1.8, 0≤b≤0.5, 0≤c≤0.5, 0<α<2); LiₐNi_{1-b-c}Mn_{b}B¹_{c}D¹_{α} (0.90≤a≤1.8, 0≤b≤0.5, 0≤c≤0.5, 0<α<2); LiₐNi_{1-b-c}Mn_{b}B¹_{c}O_{2-α}F¹_{α} (0.90≤a≤1.8, 0≤b≤0.5, 0≤c≤0.5, 0<α<2); LiₐNi_{1-b-c}Mn_{b}B¹_{c}O_{2-α}F¹₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMnG_{b}O₂ (0.90≤a≤1.8, 0.001≤b≤0.1); LiₐMn₂G_{b}O₄ (0.90≤a≤1.8, 0.001≤b≤0.1); QO₂; QS₂; LiQS₂; V₂O₅; LiV₂O₅; LiI¹O₂; LiNiVO₄, Li_{(3-f)}J₂(PO₄)₃ (0≤f≤2); Li_{(3-f)}Fe₂(PO₄)₃ (0≤f≤2); or LiFePO₄.

In the chemical formulas A is selected from Ni, Co, Mn, or a combination thereof; B¹ is selected from Al, Ni, Co, Mn, Cr, Fe, Mg, Sr, V, a rare earth element, or a combination thereof; D¹ is selected from O, F, S, P, or combination thereof; E is selected from Co, Mn, or combination thereof; F¹ is selected from F, S, P, or a combination thereof; G is selected from Al, Cr, Mn, Fe, Mg, La, Ce, Sr, V, or a combination thereof; Q is selected from Ti, Mo, Mn, or a combination thereof; I¹ is selected from Cr, V, Fe, Sc, Y, or a combination thereof; J is selected from V, Cr, Mn, Co, Ni, Cu, or a combination thereof; L¹ is selected from Mn, Al, or a combination thereof.

According to one embodiment, the positive active material may be a three-component-based lithium transition metal oxide such as LiNiₓCo_{y}Al_{z}O₂ (NCA), LiNiₓCo_{y}MnZO₂ (NCM) (wherein, 0<x<1, 0<y<1, 0<z<1, x+y+z=1), or the like.

The compounds may have a coating layer on the surface, or may be mixed with another compound having a coating layer. The coating layer may include at least one coating element compound selected from the group consisting of an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or mixture thereof. The coating layer may be provided by a method having no adverse influence on properties of a positive active material by using these elements in the compound, and for example, the method may include any suitable coating method such as spray coating, dipping, and/or the like, but is not illustrated in more detail because it should be readily recognizable to those of ordinary sill in the art upon reviewing the present disclosure.

Furthermore, the coating layer may be any coating materials which are known as a coating layer for the positive active material of the all solid battery, and the example may be Li₂O—ZrO₂ (LZO), or the like.

If the positive active material is three-components including nickel, cobalt, and manganese, or nickel, cobalt, and aluminum, the capacity density of the all solid-state battery may be further improved, the metal elution from the positive active material at charged state may be further reduced. This may render to further improve long reliability and cycle characteristics of the all solid-state battery at charged state.

The sulfur-included compound may be elemental sulfur (S₈), solid Li₂Sₙ (n≤1), catholyte in which Li₂Sₙ (n≤1) is dissolved, an organosulfur compound, a carbon-sulfur polymer [(C₂Sₓ)ₙ, X=2.5 to 50, n≤2), or a combination thereof.

The shape of the positive active material may be, for example, particle shapes such as a spherical shape and an oval spherical shape. The average particle diameter of the positive active material may not be specifically limited, and may be in any range which may be applied to a positive active material of the conventional all solid-state secondary battery. The amount of the positive active material included in the positive active material may not be limited, and may be in any range which may be applied to a positive active material of the conventional all solid-state secondary battery.

The positive active material layer may include a solid electrolyte. The solid electrolyte included in the positive active material layer may be the solid electrolyte as described above, and it may be the same or different from the solid electrolyte included in the solid electrolyte layer. The solid electrolyte may be included at an amount of 10 wt % to 30 wt % based on the total weight of the positive active material layer.

The current collector may be, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may have a foil shape or a sheet shape.

The positive active material layer may further include a binder and/or a conductive material.

The binder may be polyvinyl alcohol, carboxymethyl cellulose, hydroxypropyl cellulose, diacetylcellulose, polyvinyl chloride, carboxylated polyvinyl chloride, polyvinyl fluoride, an ethylene oxide-containing polymer, polyvinyl pyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or the like, but is not limited thereto.

The binder may be included in 0.1 wt % to 5 wt %, or 0.1 wt % to 3 wt % based on the total weight of each components of the positive electrode for the all solid-state battery, or based on the total weight of the positive active material layer. Within the range of the amount, the bunder may sufficiently exhibit adhesion ability without deteriorating the battery performance.

The conductive material is included to provide electrode conductivity, and any electrically conductive material may be used as a conductive material unless it causes a chemical change, and examples thereof may be a carbonaceous material such as natural graphite, artificial graphite, carbon black, acetylene black, ketjen black, carbon fiber, carbon nanotube, and the like; a metal-based material of a metal powder or a metal fiber including copper, nickel, aluminum, silver, and the like; a conductive polymer such as polyphenylene derivatives; or mixtures thereof.

The conductive material may be included in an amount of 0.1 wt % to 5 wt %, or 0.1 wt % to 3 wt % based on the total weight of each components of the positive electrode for the all solid-state battery, or the total weight of the positive active material layer. The conductive material within the above range may sufficiently exhibit the electrical conductivity without deteriorating the battery performance.

A thickness of the positive active material layer may be 90 μm to 200 μm. For example, the thickness of the positive active material layer may be 90 μm or more, 100 μm or more, 110 μm or more, 120 μm or more, 130 μm or more, 140 μm or more, 150 μm or more, 160 μm or more, 170 μm or more, 180 μm or more, or 190 μm or more, and 200 μm or less, 190 μm or less, 180 μm or less, 170 μm or less, 160 μm or less, 150 μm or less, 140 μm or less, 130 μm or less, 120 μm or less, or 110 μm or less. As described above, the thickness of the positive active material layer is greater than the thickness of the negative active material layer, and thus the capacity of the positive electrode is larger than the capacity of the negative electrode.

The positive electrode may be prepared by forming a positive active material layer on a positive current collector using a dry-coating or wet-coating process.

In one embodiment, the all solid-state battery may further include a buffer material for buffering a thickness variation caused from charge and discharge. The buffer material may be positioned between the negative electrode and the case or positioned between the one assembly and another assembly of the battery in which at least one electrode assembly is stacked.

The buffer material may be materials having elasticity recovery of 50% or more and insulating properties, and specifically, may be silicon rubber, acryl rubber, fluorine-based rubber, nylon, synthetic rubber, or a combination thereof. The buffer material may be a polymer sheet.

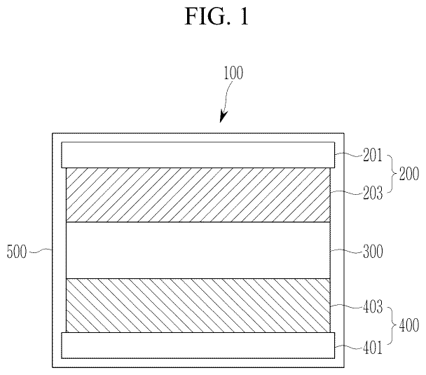

FIG. 1 is a cross-sectional view of the all solid-state battery according to one embodiment. Referring to FIG. 1, the all solid-state battery 100 may have a structure in which electrode assembly by staked with a negative electrode 400 including a negative current collector 401 and a negative electrode coating layer 403, a solid electrolyte 300, a positive electrode 200 including a positive active material layer 203 and a positive current collector 201 are housed on a case such as a pouch, or the like. The all solid-state battery 100 may further include an elasticity layer 500 on the outside of at least one of the positive electrode 200 and the negative electrode 400. FIG. 1 shows one electrode assembly including a negative electrode 400, a solid electrolyte layer 300, and a positive electrode 200, but it may be an all solid-state battery fabricated by stacking at least two electrode assemblies.

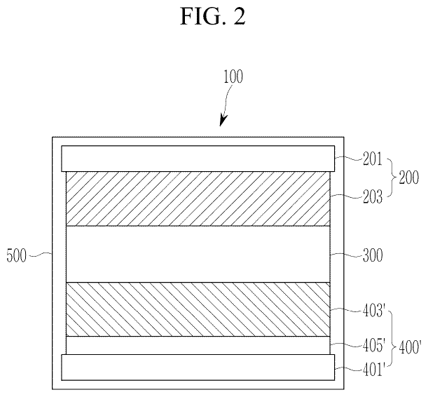

FIG. 2 FIG. 2 schematically shows the structure of the all solid-state battery in the charge state. The all solid-state battery 100 may include a positive electrode 200 including a positive current collector 201 and a positive active material layer 203, a negative electrode 400′ including a negative current collector 401′ and a negative electrode coating layer 403′, and a solid electrolyte layer 300 positioned between the positive electrode 200 and the negative electrode 400′, and may include a battery case 500 housing them.

Furthermore, lithium ions are released from a positive active material and deposited on the negative current collector 401′, and thus, a lithium-containing layer 405′ is positioned between the current collector 401′ and the negative electrode coating layer 403′.

The all solid-state battery according to one embodiment may be fabricated by positioning a negative electrode, a positive electrode, and a solid electrolyte between the negative electrode and the positive electrode to prepare an assembly and pressurizing the assembly.

The pressurization may be carried out at a temperature of 25° C. to 90° C. The pressurization may be carried out under a pressure of 550 MPa, for example, 500 MPa or less, for example, a pressure of 1 MPa to 500 MPa. The pressurization time may be varied depending on temperature and pressure, for example, it may be less than 30 minutes. The pressurization may be, for example, isostatic press, warm isostatic press, roll press, or plate press.

### Mode for Performing the Invention

Hereinafter, examples of the present invention and comparative examples are described. These examples, however, are not in any sense to be interpreted as limiting the scope of the invention.

### <Measurement of BET>

The BET surface area of carbon black used in the following experiments was determined by the following procedure.

Onto a surface of carbon black, a mixed gas of nitrogen and helium (1:1 by volume ratio) was injected, and it were injected into a U-shaped sample cell. Herein, an amount of the adsorbed gas was measured by utilizing adsorption of nitrogen gas via a thermal conductivity detector, and a specific surface area was obtained therefrom.

### Example 1

### (1) Preparation of Negative Electrode

74 wt % of carbon black with a specific surface area of 55 m²/g and an average size of 35 nm was mixed with 20 wt % of Ag with an average size of 10 nm, 2 wt % of carboxymethyl cellulose, and 4 wt % of a styrene-butadiene rubber in water to prepare a negative electrode coating layer slurry. The Ag was a mixture in which it was supported on the carbon black and the density of the mixture was 10.49 g/cm³ at 25° C.

The prepared slurry was coated on a stainless steel foil current collector and vacuum-dried at 80° C. to prepare a negative electrode including a negative electrode coating layer with a 12 μm thickness and a current collector with a 10 μm thickness.

### (2) Preparation of Solid Electrolyte Layer

To an agyrodite-type solid electrolyte Li₆PS₅Cl, an isobutylyl isobutylate binder solution (solid amount: 50 wt %) to which butyl acrylate as an acrylate-based polymer was added, was added and then mixed. A mixing ratio of the solid electrolyte and the binder was a weight ratio of 98.7:1.3.

The mixing process was carried out using a Thinky mixer. The mixture was added with a 2 mm zirconia ball and was repeatedly agitated using a Thinky mixer to prepare a slurry. The slurry was casted on a release polytetrafluoroethylene film and dried at a room temperature to prepare a solid electrolyte layer with a thickness of 100 μm.

### (4) Fabrication of all Solid-State Cell

85.0 wt % of a LiNi_{0.8}CO_{0.1}Al_{0.1}O₂ positive active material, 13.0 wt % of a lithium agyrodite-type solid electrolyte Li₆PS₅Cl, 0.5 wt % of a carbon nanotubes conductive material and 1.5 wt % of a polyvinylidene fluoride binder were mixed in an N-methyl-2-pyrrolidone solvent to prepare a positive electrode layer slurry.

The positive electrode layer slurry was coated on an aluminum current collector, dried at 80° C., and pressurized to prepare a positive electrode for an all solid-state cell.

The prepared negative electrode, the solid electrolyte layer, and the positive electrode were sequentially stacked, and the pressure was applied at a warm isostaic pressure (WIP) of 2 NM to fabricate an all solid-state cell.

### Example 2

A negative electrode was prepared by the same procedure as in Example 1, except that 89 wt % of carbon black with a specific surface area of 55 m²/g and an average size of 35 nm, 5 wt % of Ag with an average size of 5 nm, 2 wt % of carboxymethyl cellulose, and 4 wt % of a styrene-butadiene rubber were mixed in water to prepare a negative electrode coating layer slurry. The Ag was a mixture in which it was supported on the carbon black and the density of the mixture was 10.49 g/cm³ at 25° C.

Using the negative electrode, and the solid electrolyte layer and a positive electrode prepared in Example 1, an all solid-state full cell was fabricated.

### Example 3

A negative electrode was prepared by the same procedure as in Example 1, except that 69 wt % of carbon black with a specific surface area of 55 m²/g and an average size of 35 nm, 25 wt % of Ag with an average size of 5 nm, 2 wt % of carboxymethyl cellulose, and 4 wt % of a styrene-butadiene rubber were mixed in water to prepare a negative electrode coating layer slurry. The Ag was a mixture in which it was supported on the carbon black and the density of the mixture was 10.49 g/cm³ at 25° C.

Using the negative electrode, and the solid electrolyte layer and a positive electrode prepared in Example 1, an all solid-state full cell was fabricated.

### Example 4

A negative electrode was prepared by the same procedure as in Example 1, except that 86 wt % of carbon black with a specific surface area of 100 m²/g and an average size of 35 nm, 5 wt % of Ag with an average size of 3 nm, 3 wt % of carboxymethyl cellulose, and 6 wt % of a styrene-butadiene rubber were mixed in water to prepare a negative electrode coating layer slurry. The Ag was a mixture in which it was supported on the carbon black and the density of the mixture was 10.49 g/cm³ at 25° C.

Using the negative electrode, and the solid electrolyte layer and a positive electrode prepared in Example 1, an all solid-state full cell was fabricated.

### Example 5

A negative electrode was prepared by the same procedure as in Example 1, except that 79 wt % of carbon black with a specific surface area of 55 m²/g and an average size of 35 nm, 15 wt % of Ag with an average size of 20 nm, 4 wt % of carboxymethyl cellulose, and 2 wt % of a styrene-butadiene rubber were mixed in water to prepare a negative electrode coating layer slurry. The Ag was a mixture in which it was supported on the carbon black and the density of the mixture was 10.49 g/cm³ at 25° C.

Using the negative electrode, and the solid electrolyte layer and a positive electrode prepared in Example 1, an all solid-state full cell was fabricated.

### Example 6

A negative electrode was prepared by the same procedure as in Example 1, except that 89 wt % of carbon black with a specific surface area of 50 m²/g and an average size of 35 nm, 5 wt % of Ag with an average size of 30 nm, 2 wt % of carboxymethyl cellulose, and 4 wt % of a styrene-butadiene rubber were mixed in water to prepare a negative electrode coating layer slurry. The Ag was a mixture in which it was supported on the carbon black and the density of the mixture was 10.49 g/cm³ at 25° C.

Using the negative electrode, and the solid electrolyte layer and a positive electrode prepared in Example 1, an all solid-state full cell was fabricated.

### Example 7

A negative electrode was prepared by the same procedure as in Example 1, except that 86 wt % of carbon black with a specific surface area of 100 m²/g and an average size of 35 nm, 5 wt % of Ag with an average size of 30 nm, 3 wt % of carboxymethyl cellulose, and 6 wt % of a styrene-butadiene rubber were mixed in water to prepare a negative electrode coating layer slurry. The Ag was a mixture in which it was supported on the carbon black and the density of the mixture was 10.49 g/cm³ at 25° C.

Using the negative electrode and the solid electrolyte layer and a positive electrode prepared in Example 1, an all solid-state full cell was fabricated.

### COMPARATIVE EXAMPLE 1

A negative electrode was prepared by the same procedure as in Example 1, except that 89 wt % of carbon black with a specific surface area of 55 m²/g and an average size of 35 nm, 5 wt % of Ag with an average size of 40 nm (density: 3.0 g/cm³ at 25° C.), 2 wt % of carboxymethyl cellulose, and 4 wt % of a styrene-butadiene rubber were mixed in water to prepare a negative electrode coating layer slurry.

Using the negative electrode, and the solid electrolyte layer and a positive electrode prepared in Example 1, an all solid-state full cell was fabricated.

### COMPARATIVE EXAMPLE 2

A negative electrode was prepared by the same procedure as in Example 1, except that 75 wt % of carbon black with a specific surface area of 850 m²/g and an average size of 35 nm, 10 wt % of Ag with an average size of 20 nm, 5 wt % of carboxymethyl cellulose, and 10 wt % of a styrene-butadiene rubber were mixed in water to prepare a negative electrode coating layer slurry. The Ag was a mixture in which it was supported on the carbon black and the density of the mixture was 10.49 g/cm³ at 25° C.

Using the negative electrode, and the solid electrolyte layer and a positive electrode prepared in Example 1, an all solid-state full cell was fabricated.

### COMPARATIVE EXAMPLE 3

A negative electrode was prepared by the same procedure as in Example 1, except that 64 wt % of carbon black with a specific surface area of 50 m²/g and an average size of 35 nm, 30 wt % of Ag with an average size of 5 nm, 2 wt % of carboxymethyl cellulose, and 4 wt % of a styrene-butadiene rubber were mixed in water to prepare a negative electrode coating layer slurry. The Ag was a mixture in which it was supported on the carbon black and the density of the mixture was 10.49 g/cm³ at 25° C.

Using the negative electrode, and the solid electrolyte layer and a positive electrode prepared in Example 1, an all solid-state full cell was fabricated.

### COMPARATIVE EXAMPLE 4

A negative electrode was prepared by the same procedure as in Example 1, except that 84 wt % of carbon black with a specific surface area of 55 m²/g and an average size of 35 nm, 10 wt % of Ag with an average size of 70 nm (density: 3.0 g/cm³ at 25° C.), 2 wt % of carboxymethyl cellulose, and 4 wt % of a styrene-butadiene rubber were mixed in water to prepare a negative electrode coating layer slurry.

Using the negative electrode, and the solid electrolyte layer and a positive electrode prepared in Example 1, an all solid-state full cell was fabricated.

### Experimental Example 1) Measurement of TEM (Transmission Electron Microscope)

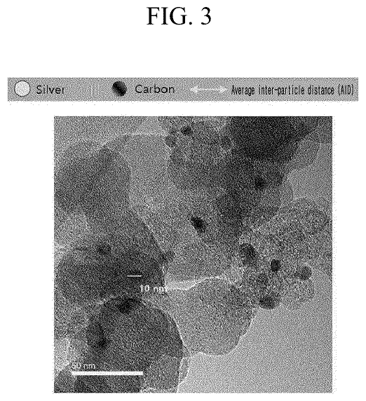

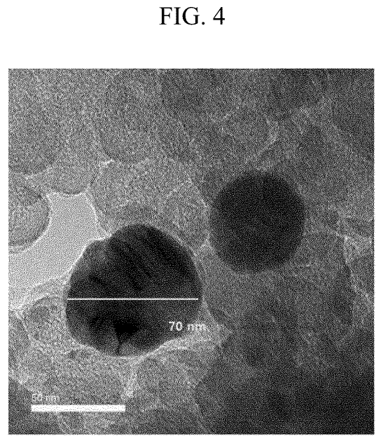

The cross-section TEM images (125000× magnification and 245000× magnification) of the negative electrodes prepared in Example 1 and Comparative Example 4 were determined by using as measured JEMARM200F available from JEOL, Ltd. Among the results, 125000× magnification-TEM image is shown in FIG. 3 and FIG. 4, respectively. As shown in FIG. 3, the Example 1 exhibited that the size of the silver particle was 10 nm, whereas, as shown in FIG. 4, Comparative Example 4 showed the size of the silver particle to be 70 nm.

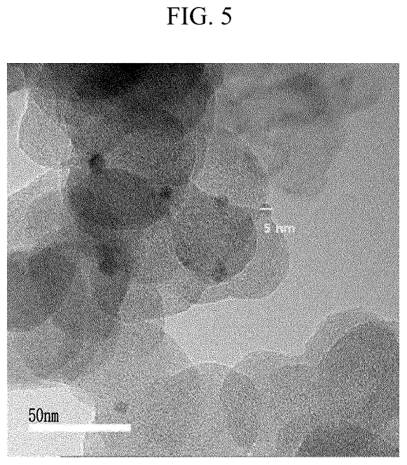

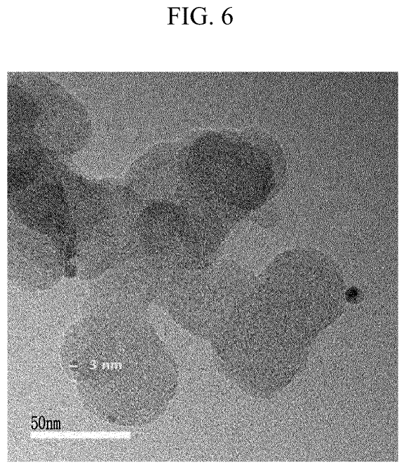

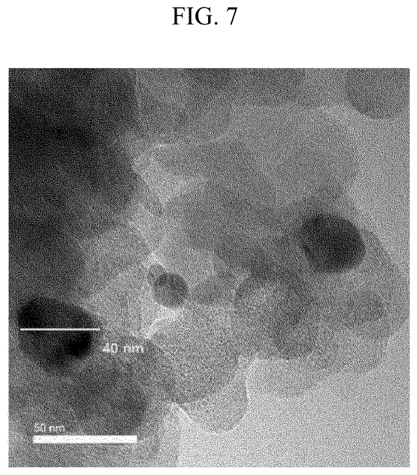

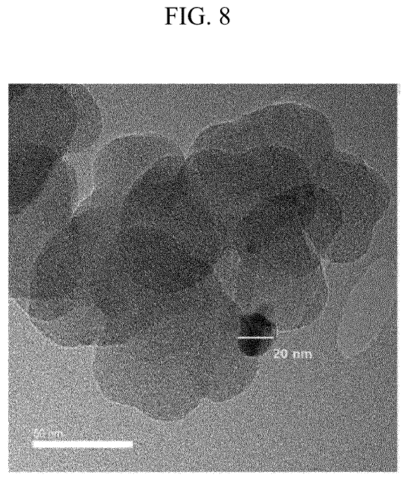

Furthermore, the cross-section TEM images (125000× magnification and 245000× magnification) of the negative electrodes prepared in Examples 2 and 4, and Comparative Examples 1 and 2 were determined using JEMARM200F available from JEOL, Ltd. Among these results, the 245000× magnification TEM images are shown in FIG. 5 (Example 2), FIG. 6 (Example 5), FIG. 7 (Comparative Example 1), and FIG. 8 (Comparative Example 2), respectively. As shown in FIG. 5 and FIG. 6, in case of Examples 2 and 4, the size of the silver particle was 5 nm and 3 nm, but as shown in FIG. 7 and FIG. 8, Comparative Example 1 was that the size of the particle was 40 nm and in case of Comparative Example 2, it was found to be 20 nm.

Among the measure results, sizes and positions were determined through Image J from the cross-sectional TEM images with magnifications of 125000 times and 245000 times of the negative electrodes according to Examples 1, 3, and 5, and Comparative Examples 1 and 4, and the average-interparticle distance, i.e., distance between particles was calculated. The results are shown in Table 1, as measurement value of the AID.

The AID values of Examples 1 to 7 and Comparative Examples 1 to 4 were calculated by Equation 1, and among these results, the results of Examples 1, 3, and 5, and Comparative Examples 1 and 4 are shown in Table 1, as calculated value of AID. Furthermore, the AID values of Examples 1 to 7 and Comparative Examples 1 to 4 calculated by Equation 1 are shown in Table 2. In case of Comparative Examples 1 and 4, p was set to the density of Ag, itself, e.g., 3.0 g/cm³ which was the density at 25° C.

$$AID = \sqrt{\frac{π}{3 \sqrt{3}} {10}^{- 3} ρ \frac{100 - L}{L} {Ad}^{3}} - d \qquad [ [ Equation 1 ]$$

(in Equation 1,
ρ is a density (g/cm³) of the mixture,
d is an average size (nm) of the metal particles,
L is an amount (wt %) of the metal particles, and,
A is a specific surface area (m²/g) of the amorphous carbon.)

### Experimental Example 2) Evaluation of Output Characteristic

The all solid-state full cells of Examples 1 to 7 and Comparative Examples 1 to 4 were charged and discharged at 45° C. under a condition of once charging at 0.1 C and discharged at 0.1 C, once charging at 0.1 C and discharging at 0.33 C, and once charging at 0.1 C and discharging at 1 C. Discharge capacity was measured and a ratio of discharge capacity at 1 C relative to discharge capacity at 0.1 C was calculated (discharge at 1.0 C/discharge capacity at 0.1 C*100). The results are shown in Table 2, as output characteristic.

### Experimental Example 3) Evaluation of Cycle-Life Characteristic

The all solid-state full cells of Examples 1 to 7 and Comparative Examples 1 to 4 were charged and discharged at 0.33 C for 100 cycles. A ratio of discharge capacity at 100th relative to discharge capacity at 1st was calculated (100th Discharge capacity/initial discharge capacity*100). The results are shown in Table 1, as cycle-life characteristic. Furthermore, in the cycle-life characteristic evaluation results, if the calculated value is 90% or more, it is marked as ◯ and if it is less than 90%, it is marked as X.

TABLE 1

| | Calculated value | Measurement value |
|---|---|---|
| | of AID (nm) | of AID (nm) |
| Example 1 | 27 | 29 |
| Example 3 | 6 | 7 |
| Example 5 | 106 | 120 |
| Comparative | 611 | 648 |
| Example 1 | | |
| Comparative | 920 | 967 |
| Example 4 | | |

As shown in Table 1, the calculated values of the AID are almost similar to the measurement values and thus, it is clear that the distance between the metal particles may be obtained from the calculated value of the AID Equation 1.

TABLE 2

| | | | Specific surface | | | Output | Cycle-life |
|---|---|---|---|---|---|---|---|
| | Metal size | Amount of | area of carbon | AID value | Carbon | characteristic | characteristic |
| | (nm) | metal (wt %) | (m²/g) | (nm) | size (nm) | (%) | (%) |
| Example 1 | 10 | 20 | 55 | 27 | 35 | 86.8 | ◯ (94.6) |
| Example 2 | 5 | 5 | 55 | 24 | 35 | 87.1 | ◯ (94.3) |
| Example 3 | 5 | 25 | 55 | 6 | 35 | 85.5 | ◯ (95.5) |
| Example 4 | 3 | 5 | 100 | 15 | 35 | 85.7 | ◯ (93.4) |
| Example 5 | 20 | 15 | 55 | 106 | 35 | 84.6 | ◯ (96.1) |
| Example 6 | 30 | 10 | 50 | 248 | 35 | 84.1 | ◯ (93.1) |
| Example 7 | 30 | 5 | 100 | 540 | 35 | 83.4 | ◯ (92.8) |
| Comparative | 40 | 5 | 55 | 611 | 35 | 77.2 | X (87.8) |
| Example 1 | | | | | | | |
| Comparative | 20 | 10 | 850 | 603 | 35 | 72.4 | X (78.6) |
| Example 2 | | | | | | | |
| Comparative | 5 | 30 | 50 | 4.6 | 35 | 79.4 | X (88.8) |
| Example 3 | | | | | | | |
| Comparative | 70 | 10 | 55 | 987 | 35 | 76.1 | X (86.3) |
| Example 4 | | | | | | | |

As shown in Table 2, the all solid half-cells having the AID value defined by Equation 1 of 5 nm or more and 600 nm or less of Examples 1 to 7 exhibited excellent output characteristic and cycle-life characteristic.

Whereas, Comparative Examples 1, 2, and 4 having the AID value defined by Equation 1 of more than 600 nm, Comparative Example 3 having the AID value defined by Equation 1 of 5 or less, exhibited deteriorated output characteristic and cycle-life characteristic.

While this disclosure has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

1. A negative electrode for an all solid-state battery, comprising:
a current collector; and
a negative electrode coating layer on the current collector and comprising a mixture of metal particles and amorphous carbon,
wherein an AID value defined by Equation 1 satisfies 5 nm or more and 600 nm or less.
$$AID = \sqrt{\frac{π}{3 \sqrt{3}} {10}^{- 3} ρ \frac{100 - L}{L} {Ad}^{3}} - d \qquad [ Equation 1 ]$$
(in Equation 1,
ρ is a density (g/cm³) of the mixture,
d is an average size (nm) of the metal particles,
L is an amount (wt %) of the metal particles, and
A is a specific surface area (m²/g) of the amorphous carbon.)

2. The negative electrode for an all solid-state battery as claimed in claim 1, wherein the metal particle is Ag, Au, Sn, Zn, Al, Mg, Ge, Cu, In, Ni, Bi, Pt, Pd, or a combination thereof.

3. The negative electrode for an all solid-state battery as claimed in claim 1, wherein the d which is the average size of the metal particles is 3 to 30.

4. The negative electrode for an all solid-state battery as claimed in claim 1, wherein the L which is the amount of the metal particles is 5 to 25.

5. The negative electrode for an all solid-state battery as claimed in claim 1, wherein the A which is the specific surface area of the amorphous carbon is 30 to 100.

6. The negative electrode for an all solid-state battery as claimed in claim 1, wherein a ratio of a size of the amorphous carbon to a size of the metal particle is 1:0.05 to 1:1.

7. The negative electrode for an all solid-state battery as claimed in claim 1, wherein the AID value of Equation 1 is 5 nm to 400 nm.

8. The negative electrode for an all solid-state battery as claimed in claim 1, wherein the amorphous carbon is carbon black, acetylene black, denka black, Ketjen black, furnace black, activated carbon, or a combination thereof.

9. The negative electrode for an all solid-state battery as claimed in claim 1, wherein the density is a value measured at 20° C. to 25° C.

10. An all solid-state battery, comprising:
a negative electrode of claim 1;
a positive electrode; and
a solid electrolyte layer between the negative electrode and the positive electrode.

11. The all solid-state battery as claimed in claim 10, wherein the negative electrode further comprises a lithium-containing layer between the current collector and the negative electrode coating layer.
